(19) United States
(12) Patent Application Publication
(10) Pub. No.: US 2025/0108319 A1
(43) Pub. Date: Apr. 3, 2025

(54) HYDRAULIC FLUID FILTER WITH INTEGRATED BYPASS

(71) Applicant: Caterpillar Inc., Peoria, IL (US)

(72) Inventors: Bruno L. Risatti, Lemont, IL (US); Bryan W. Rickards, Peoria, IL (US)

(21) Appl. No.: 18/829,012

(22) Filed: Sep. 9, 2024

Related U.S. Application Data
(60) Provisional application No. 63/542,227, filed on Oct. 3, 2023.

(51) Int. Cl. B01D 29/58; B01D 29/11; B01D 35/147

(52) U.S. Cl. CPC B01D 29/58; B01D 29/117; B01D 35/147; B01D 2201/184; B01D 2201/188; B01D 2201/287

(57) ABSTRACT

This disclosure describes a filter element for hydraulic fluid that includes a first filter component having a first filter size and a second filter component having a second filter size. The first filter component may be arranged within a housing to filter the hydraulic fluid between an inlet and an outlet of the filter element. The second filter component may include a screen, mesh, or other filter media with the second filter size (e.g., mesh size) greater than the first filter size. The second filter component may include a screen for a bypass valve. The bypass valve may be integrated within the filter element and provide a second outlet through the filter element. The outlet and the second outlet from the filter element may re-join downstream of the bypass valve to provide a single outlet flow vector from a filter system.

### RELATED APPLICATION

This application claims priority from U.S. Provisional Application No. 63/542,227, filed Oct. 3, 2023, the entire disclosure of which is incorporated by reference and for all purposes.

### TECHNICAL FIELD

The present disclosure relates to filters and breathers used to remove contaminants various fluids such as hydraulic fluid, air filtration, oil, and fuel, etc. used to power the mechanisms and engines of earth moving, construction and mining equipment and the like (e.g., automotive, agriculture, HVAC (heating, ventilation and air conditioning), locomotive, marine, exhaust treatment or any other industry where filters and breathers are useful). Specifically, the present disclosure relates to filters that are manufactured having an integrated bypass rather than a separate bypass that enables servicing the bypass when servicing the filter element.

### BACKGROUND

Earth moving, construction and mining equipment and the like often use filters and/or breathers used to remove contaminants various fluids such as hydraulic fluid, oil, and fuel, etc. used to power the mechanisms and engines of the equipment. Over time, contaminants collect in the fluid that may be detrimental to the components of the various mechanisms (e.g., hydraulic cylinders) and the engines, necessitating repair. The goal of the filters and/or breathers is to remove the contaminants in the various fluids to prolong the useful life of these components. Any industry using filters and/or breathers may also need to remove contaminants from hydraulic fluid, air, oil, and fuel, etc. Examples of these other industries, include but are not limited to, automotive, agriculture, HVAC, locomotive, marine, exhaust treatment, etc.

The technologies typically used to provide the filter media include folding porous fabric or other materials that remove the contaminants. Filter center tubes may be employed to help prevent the fabric from collapsing. Collapsing the filter media may hinder the effectiveness of the filter to remove contaminants while allowing a sufficient flow of fluid through the filter to supply the various systems of the equipment.

The filter center tube may occupy a considerable amount of space in the interior of the filter, limiting the rate at which fluid may flow through the filter while still maintaining a desirable level of contamination removal. That is to say, the throughput of the filter may be reduced due to the center tube which only provides support and no filtering function.

Filter systems and filter elements that are used to filter a fluid such as hydraulic fluid are well-known in all fields that use hydraulic systems including earthmoving, construction and mining equipment. A filter system is often provided that separates water or contaminants from the fuel before it enters the engine. A filter element is often provided as part of this system that includes a filter media wrapped around a center tube. The configuration of the tube and the filter media is often substantially circular or cylindrical.

An example of a filter element is described with respect to U.S. Pat. No. 9,410,456 (“the '456 patent”). The filter element is designed for use with a liquid medium such as motor oil or transmission oil. Due to pressure variations within the filter system during operation of the system, a bypass duct is provided that enables fluid to bypass the fluid filter to normalize pressure through the system as required. Typical bypass systems allow contaminants to pass through the system by bypassing the filter entirely and therefore do not function to filter out contaminants that may damage the system. The filter element of the '456 patent allows a bypass through a sieve that removes solid contaminants. Further, typical bypass valves exit through a separate vector or port that differs from the vector or port that filtered fluid passes through downstream of the filter.

Examples of the present disclosure are directed toward overcoming the deficiencies described above.

### SUMMARY

One general aspect includes a filter element for filtering hydraulic fluid. The filter element also includes a cylindrical housing having an inlet positioned at a first end and an outlet positioned at the first end. The element also includes a filter material arranged within the cylindrical housing, the filter material having a cylindrical shape such that the hydraulic fluid flows from the inlet through the filter material in a flow direction that is radial to a longitudinal axis of the cylindrical housing to the outlet. The element also includes a bypass valve positioned at a second end of the cylindrical housing. The element also includes a screen element positioned adjacent the bypass valve within the cylindrical housing, the screen element configured to screen material from the hydraulic fluid before it passes through the bypass valve.

Implementations may include one or more of the following features. The filter material has a first filter size and the screen element has a second filter size, where the second filter size is greater than the first filter size. The second filter size is in a range of five times the first filter size or greater. The second filter size is in a range of 10 microns to greater than 40 microns. The screen element has a frusto-conical shape surrounding an entry to the bypass valve within the cylindrical housing. The filter element may include a mounting plate coupled to the second end of the cylindrical housing, the mounting plate configured to couple the filter element to a filter system of a hydraulic system. The screen element may include a wire mesh and the filter material may include a layered filter media. The filter system may include a mounting plate coupled to the second end of the cylindrical housing, the mounting plate configured to couple the filter system to a hydraulic system. The outlet defines a passage through the cylindrical housing and the mounting plate. Fluid flows through the inlet in a first direction parallel with the longitudinal axis and passes through the filter media in a flow direction that is radial to the longitudinal axis of the cylindrical housing and subsequently flows through the outlet in a second direction opposite the first direction. The hydraulic fluid filter element is removable from the hydraulic system for replacement. The bypass outlet may include a controlled bypass valve configured to controllably open to enable hydraulic fluid to flow through the bypass outlet in parallel with the outlet.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a hydraulic filter system with a replaceable filter having an integrated bypass included within the fluid filter showing fluid flow through a filter media flow path, according to at least one example.

FIG. 2 illustrates the hydraulic filter system of FIG. 1 with a replaceable filter having an integrated bypass included within the fluid filter showing fluid flow through the bypass flow path, according to at least one example.

FIG. 3 illustrates the hydraulic filter system of FIG. 1 with a replaceable filter having an integrated bypass included within the fluid filter showing shared fluid flow through the filter media flow path and the bypass flow path, according to at least one example.

### DETAILED DESCRIPTION

Wherever possible, the same reference numbers will be used throughout the drawings to refer to the same or like parts.

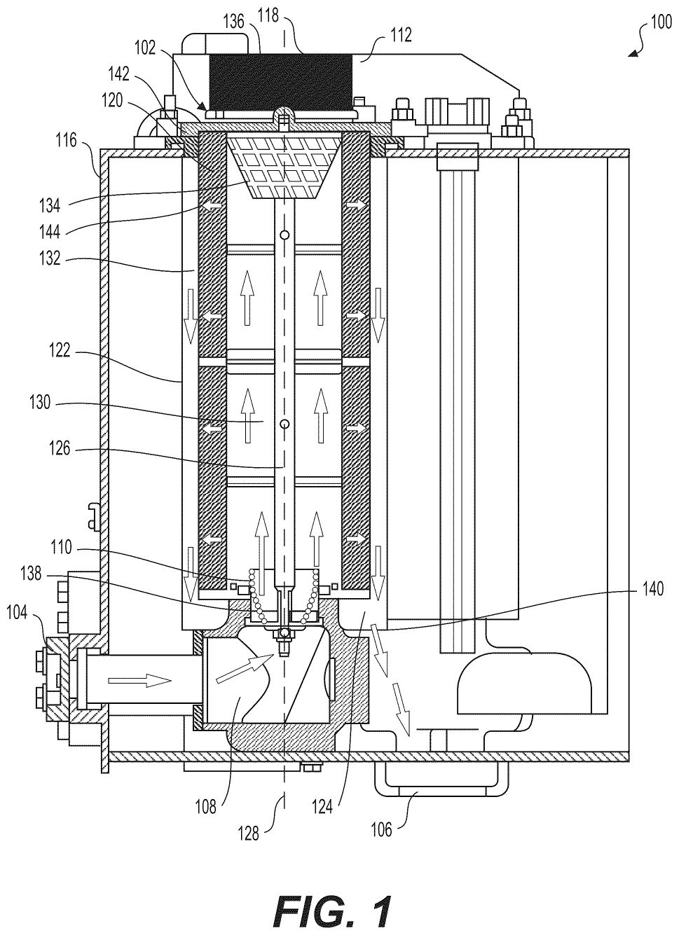

FIG. 1 illustrates a hydraulic filter system 100 with a filter element 102 having an integrated bypass included within the hydraulic filter system 100, according to at least one example. Though examples herein may be described with respect to hydraulic fluid filters, the embodiments and description provided may be implemented in other filter systems for other fluids. Additionally, though shown and described herein with reference to particular geometry, e.g., particular flow path routing, inlet and outlet locations, media flow paths, etc., the hydraulic filter system 100 may be implemented with other geometric examples and shapes and/or designs as needed for particular installations. In some examples, the shape and/or layout of the hydraulic filter system 100 may be different than shown in the figures, however the filter element 102 with an integrated bypass screen 134 may be implemented in such examples having different shapes and/or designs.

Filters and/or filter media discussed herein may be used to remove contaminants in any type of fluid, including hydraulic fluid, oil, fuel, etc. and may be used in any industry including earth moving, construction and mining, etc. As used herein, the term “filter” is to be interpreted to include “breathers” or any device used to remove contaminants from fluids as described anywhere herein. Also, any suitable industry as previously described herein that uses filters and/or breathers may use any of the embodiments discussed herein.

The present description relates to filter arrangements and filter apparatuses which include filter arrangements for filtering any of numerous contaminants from a wide variety of fluids. The fluids may be gases, liquids, and/or mixtures of gases, liquids, and/or solids. The contaminants may be, for example, solids, colloids, and/or gels and are often in the form of particles or particulates. Filter arrangements and filter assemblies embodying the invention are useful in many different fluid systems. In one of many examples, embodiments of the invention may be used to filter solid and/or colloidal particles from hydraulic or lubrication oil used in large mechanical or electromechanical devices, including wind turbines for generating electricity.

The hydraulic filter system 100 described herein may include a filter element 102, which may be disposable, mounted within the hydraulic filter system 100. A fluid may be directed through the hydraulic filter system 100 from a flow inlet 104. The filter element 102 may include a permeable filter medium for removing contaminants from the fluid. Initially, the filter media 120 is clean and a relatively small difference in pressure between the upstream and downstream surfaces will maintain an ample flow of fluid through the filter element 102. As more fluid passes through the filter element 102, the filter media 120 may become increasingly clogged or fouled. The pressure difference between the upstream and downstream surfaces may increase and/or the flow of fluid through the filter element 102 may decrease.

For many applications, it is often preferable to maintain a sufficient flow of fluid through the filter element 102 or the hydraulic filter system 100, even when the filter media 120 is significantly fouled. Consequently, embodiments described herein further include a bypass assembly which allows the fluid to bypass the filter element 102 when the filter media 120 is fouled. The bypass assembly may include a bypass valve that may be integrated with the filter element 102 and may be protected by a secondary filter element such as screen element 134 described below. The filter element 102 may be removably mounted at least partially in the interior of the hydraulic filter system 100. Replacement or cleaning of the filter element 102 will include replacement or cleaning of the screen element 134 in addition to replacement or cleaning of the filter media 120. In some examples, the screen element 134 may have a filter opening or open area that is coarser than the filter media 120. The bypass valve may open when the filter element 102 becomes sufficiently fouled that the pressure difference across the filter element 102 exceeds a predetermined value, allowing unfiltered fluid to bypass or flow around the fouled filter element 102. The screen element 134 may be positioned in the filter element 102 to remove at least the larger contaminants that might otherwise damage components of the bypass valve.

The bypass valve 136 may open in other circumstances even if the filter element 102 is not fouled. For example, during a cold startup of a fluid system, the cold, unfiltered fluid may be very thick or viscous. Forcing a cold, viscous unfiltered fluid through the fine filter media of the filter element 102 might damage, e.g., rip or tear, the fine filter medium. However, a pressure difference large enough to force the cold, viscous unfiltered fluid through the filter element 102 may exceed the predetermined value for opening the bypass valve. The open bypass valve allows the cold, viscous unfiltered fluid to bypass the filter element 102 without damaging the finer filter medium and to pass through the screen element 134. The filter medium of the screen element 134 may be a coarser filter medium and/or a more robust porous medium. Consequently, the cold, viscous unfiltered fluid passes through the screen element 134 without damaging the filter element 102. Consequently, a bypass flow of at least coarsely filtered fluid may be provided for the hydraulic filter system 100 even during a cold startup. After the fluid system has been running for a while, the unfiltered fluid becomes warmer and thinner or less viscous. The pressure difference needed to force the warm, less viscous unfiltered fluid through the filter element 102 may then fall below the predetermined value for opening the bypass valve. The bypass valve may then close, redirecting the warm, less viscous unfiltered fluid through the filter element 102.

In some examples, the bypass valve 136 may be controllable, for example to provide for controllable flow sharing through the filter media 120 as well as through the bypass valve. For example, a solenoid or other actuator coupled to the bypass valve may override the bypass valve to enable fluid to pass through the bypass valve without requiring a buildup of pressure, for example during a cold start or other such instance. Further, if the fluid system detects a flow restriction at the hydraulic filter system 100, for example that may result in cavitation of the fluid or starvation of one or more downstream components, then the bypass valve may be controlled to open at least partially to provide for fluid flow to prevent starvation, pressure buildup, or other flow restrictions.

The hydraulic filter system 100 may be implemented on a machine, such as an earth moving machine and/or in a stationary configuration. The hydraulic filter system is configured to filter hydraulic fluid as it circulates through the hydraulic system to remove contaminants such as solids, contaminant liquids, or other such contaminants. The hydraulic filter system 100 may therefore receive fluid at a flow inlet 104. The inlet may couple to one or more other components of a hydraulic system and may be placed within the hydraulic system to enable servicing of the filter element 102 as needed. The hydraulic filter system 100 provides passages 108 and 112 to enable the fluid to flow, following the arrows depicted in FIG. 1 from the flow inlet 104 to a flow outlet 106 where the fluid is provided to a downstream component of the hydraulic system.

Fluid filters typically implement a flow relief or bypass to prevent structural failure and desorption due to high pressure loads induced by flow and viscosity throughout an operating cycle. The bypass of fluid that may contain harmful contaminants means that the hydraulic system may be burdened with such contaminants that may impact the hydraulic system and/or hydraulic fluid and lead to shortened life for various components within the system as well as increased service intervals.

In typical hydraulic filter systems, the bypass for fluid may include a bypass valve that is positioned at or near an inlet into the filter element. In this manner, the fluid may bypass the filter entirely to provide pressure normalization as described herein. Typical hydraulic fluid filter designs may not protect bypass or relief valves from fluid coming out of a fluid filter. Generally, the fluid filters require a flow relief or a bypass to prevent structural failure and desorption due to high pressure loads induced by flow and viscosity. The fluid that goes through the bypass may include contaminants that should be removed to prevent damage to the fluid system.

The hydraulic filter system 100 described herein provides for a bypass valve 136 and filter system that includes an integrated bypass screen 134 that protects the bypass valve 136 from contaminants without requiring a separate set of steps to clean the protection element other than to change the filter element. In this manner, service to the hydraulic filter system 100 is simplified and improved, thereby improving the likelihood that the hydraulic filter system, and especially the bypass valve, are regularly serviced and functioning properly, thereby reducing machine downtime for maintenance and service.

The hydraulic filter system 100 provides for these benefits by enabling the bypass valve to be relocated such that fluid flows into the filter element to reach the bypass and passes through one or more screening elements before reaching the bypass valve. In this manner, the bypass valve is protected from contaminants while also enabling simple and easy cleaning and replacement of the filter and screening element in a single operation.

More particularly, the hydraulic filter system 100 provides for a filter element 102 with an integrated screen element 134 for screening fluid passing through the bypass valve. The screen element 134 is integrated inside the filter element 102 so that the fluid flows through the screen element 134 before reaching bypass valve 136. The screen element 134 thereby protects the bypass valve 136 from debris and contaminants while still allowing fluid to pass through the screen element 134 even in the event that the filter element 102 is restricted due to absorbing contaminants into filter media. Therefore, a service and health of the hydraulic fluid system is improved because the screen may be serviced with the filter element 102 and avoid screen element failure of a downstream screen by aligning service intervals with the integrated filter element 102. Integration of a screening element inside of the filter element 102 protects the bypass valve or relief feature from improper function due to large particles flowing over the bypass valve and causing accelerated wear and damage.

Additionally, the hydraulic filter system 100 provides for a parallel flow vector out of the bypass valve as well as out of the filter element 102 (e.g., for fluid that passes through the filter media). The parallel flow vector results in an flow outlet 106 for hydraulic fluid that enables the hydraulic filter system 100 to have a simplified geometry.

Within the hydraulic filter system 100, a first valve 110 is positioned at a filter inlet of the filter element 102 that may be actuated through an actuation mechanism 126 such as by turning a threaded element to move the first valve 110 along a longitudinal axis 128 of the filter element 102 and thereby open and/or close the opening into the filter element 102. This may enable the flow of fluid to be shut off for servicing the filter element 102.

The filter element 102 includes a housing 122 that encloses the filter media 120. The filter element 102 is shown having a cylindrical shape with a longitudinal axis 128 that extends along the length of the housing 122. The filter element 102 includes a filter passageway 130 where fluid flows into the filter element 102 from the flow inlet 104 through passage 108. The filter media 120 is arranged within the housing 122 in an annular cylinder shape such that the filter passageway 130 is entirely surrounded by the filter media 120. The fluid may pass radially, as shown by the arrows of FIG. 1, through the filter media 120 to a post-media passageway 132 that lies between an external surface of the filter media 120 and an internal surface of the housing 122.

In some examples, the filter element 102 may have a different geometry and/or layout for example it may not have a radial flow path through the filter element 102. In any event, the hydraulic fluid passes through the filter inlet 138 and subsequently flows through a media flow path 144 (indicated by arrows) from the filter passageway 130 to the post-media passageway 132, regardless of the geometry of the filter element 102.

The filter inlet 138 to the filter element includes a central passage into the central passageway that is surrounded by a filter outlet 140. The filter outlet 140 enables fluid that passes through the filter media 120 to exit the filter element 102 at a first end of the housing 122, where the filter inlet 138 is also positioned at the first end of the housing 122. One or more seals may seal the filter inlet 138 from the filter outlet 140 such that no contaminants bypass the filter element 102 at the entrance to the filter element 102.

Returning to FIG. 1, the filter element 102 includes a screen element 134. The screen element 134 provides integrated screening of fluid before passing to a bypass valve 136 that enables fluid to exit the filter element at a second end opposite the first end, into the passage 112. The screen element 134 is integrated inside the filter element 102 so that the fluid flows through the screen element 134 before a bypass valve 136 or relief valve from large debris.

The screen element 134 is shown as a mesh screen that may have pores or apertures that are larger than pores of the filter media 120. In an example, the pores of the screen element 134 may be five or more times larger than the pores of the filter media 120. The screen element 134 is illustrated having a frusto-conical shape, though other shapes and configurations may be implemented to protect the bypass valve from contaminants and retain said contaminants within the housing 122 of the filter element 102. The screen elements may include a wire mesh formed of a metal material, a synthetic material, or other porous media that has openings, pores, or apertures larger than the pores of the filter media 120. In an illustrative example, the screen element may be five or more times looser (e.g., more open) than the pores of the filter media 120. For instance, the diameter or open area of the apertures in the screen material may be five or more times the diameter or open area of the pores in the filter media. In a particular example, the filter media 120 may have pores that are less than 10 microns across (e.g., diameter) while the screen may have pores or openings that are greater than 40 or 50 microns across.

The filter element 102 may include a cylindrical annular shaped component formed of filter media 120 disposed radially between the filter passageway 130 and the outer wall of the housing 122. The filter media 120 may include traditional filter media such as folded fabric having apertures or pores. In some examples, the filter media 120 may include layered filter media. In some examples, the screen element 134 may define larger sized apertures compared to the pores of the filter media 120. Fluid flow through the filter element 102 is designated by arrows. The fluid flow may be reversed in some examples.

These various configurations, spatial relationships, and dimensions may be varied as needed or desired to be different than what has been specifically shown and described in other embodiments. For example, the pore size may be as big as desired or may be as small as desired. Also, the number and placement of the inlets and outlets may be varied as needed or desired in various embodiments.

As just mentioned, a plurality of filtering stages may be provided in filter media 120 that may be layered with varying types or materials of filter media, so that larger sized contaminants are filtered out in a first stage by the filter media 120, finer contaminants are filtered out in a second stage by second filter media that is disposed radially around the first stage, etc. As many filtering states as needed or desired may be provided in various embodiments (up to and including the nth stage). In some examples, the first filter media may be configured to remove water, the second filter media may be configured to remove debris, or vice versa, etc. In some embodiments, the first filter media and the second filter media are separate components that may be inserted into the housing 122. In such a case, the housing 122 of the filter element 102 is separate from the first filter media and the second filter media. In some examples, the first filter media and the second filter media are integral with the housing 122 and/or each other.

The fluid flows out of the filter element 102 and from the bypass valve (via bypass flow path 114) to the flow outlet 106, which serves as a single outlet for the hydraulic filter system 100. Accordingly, the hydraulic filter system 100 provides for a parallel flow vector out of the bypass valve as well as out of the filter element 102 (e.g., for fluid that passes through the filter media). The parallel flow vector results in a flow outlet 106 as a single delivery vector out of the hydraulic filter system 100 for hydraulic fluid that enables the hydraulic filter system 100 to have a simplified geometry.

To remove, replace, and or service the filter element 102 from the hydraulic filter system 100, an end cap 118 that defines, at least partially, passage 112 may be removed to gain access to the internal space of the hydraulic filter system 100. After removing the end cap 118, the filter element 102 may be serviced which includes simultaneous service of the filter element 102 and the screen element 134. The filter element 102 may be secured to the hydraulic filter system 100 through a mounting plate 142.

The filter element 102 is depicted having a housing 122 with a cylindrical shape, though other shapes, geometries, and configurations are envisioned. The filter element 102 further includes the filter media 120, filter passageway 130, post-media passageway 132, and screen element 134 described above. The filter element 102 further includes a bypass valve 136 that may be biased by a spring element to provide bypass for fluid through the filter element 102 as a result of pressure buildup within the filter element 102.

The filter element 102 includes the housing 122 that encloses the filter media 120. The filter element 102 is shown having a cylindrical shape with a longitudinal axis 128 that extends along the length of the housing 122. The filter element 102 includes a filter passageway 130 where fluid flows into the filter element 102 from the flow inlet 104 through passage 108. The filter media 120 is arranged within the housing 122 in an annular cylindrical shape such that the filter passageway 130 is entirely surrounded by the filter media 120. The fluid may pass radially, as shown by the arrows of FIG. 1, through the filter media 120 to a post-media passageway 132 that lies between an external surface of the filter media 120 and an internal surface of the housing 122.

The filter inlet 138 to the filter element includes a central passage into the central passageway that is surrounded by an filter outlet 140. The filter inlet 138 and filter outlet 140 are positioned at a first end of the housing 122 opposite from the bypass valve 136, positioned at a second end of the housing 122. The filter outlet 140 enables fluid that passes through the filter media 120 to exit the filter element 102 at the first end of the housing 122, where the filter inlet 138 is also positioned at the first end of the housing 122. One or more seals seal the filter inlet 138 from the filter outlet 140 such that no contaminants bypass the filter element 102 at the entrance to the filter element 102.

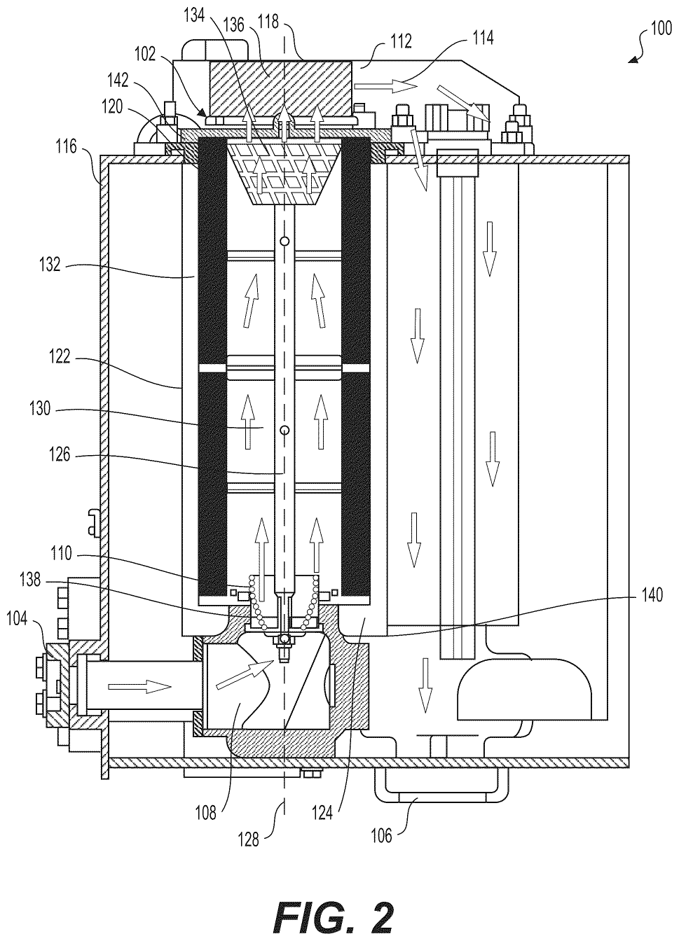

FIG. 2 illustrates the hydraulic filter system of FIG. 1 with a replaceable filter having an integrated bypass included within the fluid filter showing fluid flow through the bypass flow path, according to at least one example. In the example shown in FIG. 2, the filter media 120 of the filter element 102 may be fouled, plugged, or otherwise restrictive of flow. In such examples, the bypass valve 136 and spring are configured to provide a sufficient flow of fluid through the filter element 102 or the hydraulic filter system 100, even when the filter media 120 is fouled, either partially or wholly. Consequently, examples described herein further include the bypass valve 136 which allows the fluid to bypass the filter element 102 when the filter media 120 is fouled. The bypass valve 136 may be integrated with the filter element 102 and may be protected by a secondary filter element such as screen element 134 described herein. In some examples, the bypass valve 136 may be separate from the filter element 102 but still in the flow path of hydraulic fluid.

The filter element 102 may be removably mounted at least partially in the interior of the hydraulic filter system 100. Replacement or cleaning of the filter element 102 may include replacement or cleaning of the screen element 134 in addition to replacement or cleaning of the filter media 120. In some examples, the screen element 134 may have a filter opening or open area that is coarser than the filter media 120. The bypass valve 136 may open when the filter element 102 becomes sufficiently fouled that the pressure difference across the filter element 102 exceeds a predetermined value, allowing unfiltered fluid to bypass or flow around the fouled filter element 102. The screen element 134 may be positioned in the filter element 102 to remove at least the larger contaminants that might otherwise damage components of the bypass valve.

Accordingly, as the filter media 120 is fouled, the flow path through the filter media 120 may be blocked resulting in a pressure buildup and/or pressure differential across the hydraulic filter system 100. The pressure differential may result in the bypass valve 136 opening to allow hydraulic fluid to flow through the bypass valve 136 and into the passage 112 through the bypass flow path 114 to the flow outlet 106.

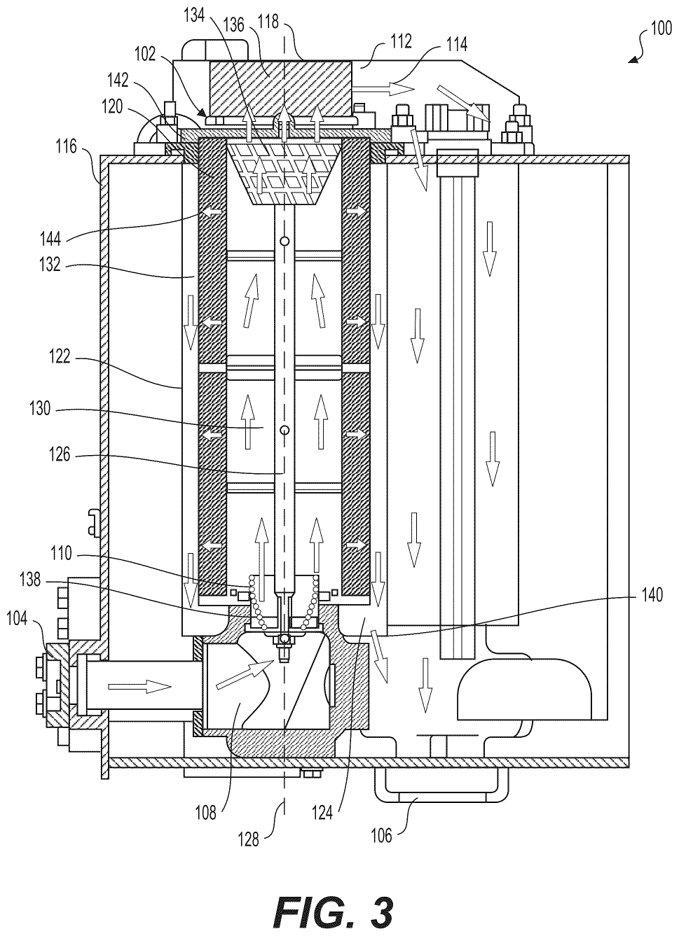

FIG. 3 illustrates the hydraulic filter system of FIG. 1 with a replaceable filter having an integrated bypass included within the fluid filter showing shared fluid flow through the filter media flow path and the bypass flow path, according to at least one example. The bypass valve 136 may open in other circumstances even if the filter element 102 (e.g., filter media 120) is not fouled. For example, during a cold startup of a fluid system, the cold, unfiltered fluid may be very thick or viscous. Forcing a cold, viscous unfiltered fluid through the filter media 120 of the filter element 102 might damage, e.g., rip or tear, the fine filter medium. However, a pressure difference large enough to force the cold, viscous unfiltered fluid through the filter element 102 may exceed the predetermined value for opening the bypass valve 136. The open bypass valve 136 allows the cold, viscous unfiltered fluid to bypass the filter element 102 without damaging the finer filter medium and to pass through the screen element 134. The filter medium of the screen element 134 may be a coarser filter medium and/or a more robust porous medium. Consequently, the cold, viscous unfiltered fluid passes through the screen element 134 without damaging the filter element 102. Consequently, a bypass flow of at least coarsely filtered fluid may be provided for the hydraulic filter system 100 even during a cold startup. After the fluid system has been running for a while, the unfiltered fluid becomes warmer and thinner or less viscous. The pressure difference needed to force the warm, less viscous unfiltered fluid through the filter element 102 may then fall below the predetermined value for opening the bypass valve 136. The bypass valve 136 may then close, redirecting the warm, less viscous unfiltered fluid through the filter element 102.

In some examples, the bypass valve 136 may be controllable, for example to provide for controllable flow sharing through the filter media 120 as well as through the bypass valve 136. For example, a solenoid or other actuator coupled to the bypass valve 136 may override the bypass valve 136, e.g., by overcoming the spring, to enable fluid to pass through the bypass valve 136 without requiring a buildup of pressure, for example during a cold start or other such instance. Further, if the fluid system detects a flow restriction at the hydraulic filter system 100, for example that may result in cavitation of the fluid or starvation of one or more downstream components, then the bypass valve 136 may be controlled to open at least partially to provide for fluid flow to prevent starvation, pressure buildup, or other flow restrictions.

As shown in FIG. 3, the flow of hydraulic fluid through the filter system may proceed through the filter media 120 as well as through the bypass valve 136 in parallel. For instance, the bypass valve 136 may be controlled to enable fluid flow through the hydraulic filter system 100, for example during a cold start of the machine. In the example of FIG. 3, the fluid may flow through the filter inlet 138 from passage 108 and into the fluid filter. A first portion of the fluid may pass through the filter media 120 and through the filter outlet 140 to the flow outlet 106. A second portion of the fluid may pass through the bypass valve 136 (e.g., after passing through the screen element 134) and through passage 112 along the bypass flow path 114 to flow outlet 106. In this manner, the fluid may flow in parallel through the fluid system to the flow outlet 106 ensuring that the hydraulic fluid is provided to the machine as-needed. The single outlet through flow outlet 106 enables fluid to pass through the filter media 120 and/or the bypass valve 136 to the flow outlet 106 which simplifies the implementation on a machine as the hydraulic fluid need only be routed to the passage 108 and from the flow outlet 106 regardless of which flow path the fluid takes (e.g., either through the filter media 120 and/or through the bypass valve 136).

### INDUSTRIAL APPLICABILITY

The present disclosure provides systems for filtering fluid, especially hydraulic fluid within a fluid system. The disclosure provides for a filter according to any embodiment described herein that may be sold, bought, manufactured or otherwise obtained in an OEM (original equipment manufacturer) or after-market context (e.g., a replacement part).

The hydraulic filter described herein provides for a bypass valve and filter that protects the bypass valve from contaminants without requiring a separate set of steps to clean the protection element other than to change the filter element. In this manner, service to the filter system is simplified and improved, thereby improving the likelihood that the hydraulic filter system, and especially the bypass valve, are regularly serviced and functioning properly, thereby reducing machine downtime for maintenance and service.

More particularly, the filter system provides for a filter element with an integrated screen element for screening fluid passing through the bypass valve. The screen element is integrated inside the filter element so that the fluid flows through the screen element before reaching by bypass valve. The screen element thereby protects the bypass valve from debris and contaminants while still allowing fluid to pass through the screen element even in the event that the filter element is restricted due to absorbing contaminants into filter media or other such instances. Therefore, a service and health of the hydraulic fluid system is improved because the screen may be serviced with the filter element and avoid screen element failure of a downstream screen by aligning service intervals with the integrated filter element. Integration of a screening element inside of the filter element protects the bypass valve or relief feature from improper function due to large particles flowing over the bypass valve and causing accelerated wear and damage.

The bypass valve may provide additional benefits to the fluid system in other circumstances even if the filter element is not fouled. For example, during a cold startup of a fluid system, the cold, unfiltered fluid may be very thick or viscous. Forcing a cold, viscous unfiltered fluid through the fine filter media of the filter element might damage, e.g., rip or tear, the fine filter medium. However, a pressure difference large enough to force the cold, viscous unfiltered fluid through the filter element may exceed the predetermined value for opening the bypass valve. The open bypass valve allows the cold, viscous unfiltered fluid to bypass the filter element without damaging the finer filter medium and to pass through the screen element. The filter medium of the screen element may be a coarser filter medium and/or a more robust porous medium. Consequently, the cold, viscous unfiltered fluid passes through the screen element without damaging the filter element. Consequently, a bypass flow of at least coarsely filtered fluid may be provided for the hydraulic filter system even during a cold startup. After the fluid system has been running for a while, the unfiltered fluid becomes warmer and thinner or less viscous. The pressure difference needed to force the warm, less viscous unfiltered fluid through the filter element may then fall below the predetermined value for opening the bypass valve. The bypass valve may then close, redirecting the warm, less viscous unfiltered fluid through the filter element.

Additionally, the hydraulic filter system provides for a parallel flow vector out of the bypass valve as well as out of the filter element (e.g., for fluid that passes through the filter media). The parallel flow vector results in a single outlet for hydraulic fluid that enables the filter system to have a simplified geometry for ease of implementation and reduction in complexity of fluid plumbing systems.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A filter element for filtering hydraulic fluid, the filter element comprising:
a cylindrical housing having an inlet positioned at a first end and an outlet positioned at the first end;
a filter material arranged within the cylindrical housing, the filter material having a cylindrical shape such that the hydraulic fluid flows from the inlet through the filter material in a flow direction that is radial to a longitudinal axis of the cylindrical housing to the outlet;
a bypass valve positioned at a second end of the cylindrical housing; and
a screen element positioned adjacent the bypass valve within the cylindrical housing, the screen element configured to screen material from the hydraulic fluid before it passes through the bypass valve.

2. The filter element of claim 1, wherein the filter material has a first filter size and the screen element has a second filter size, wherein the second filter size is greater than the first filter size.

3. The filter element of claim 2, wherein the second filter size is in a range of five times the first filter size or greater.

4. The filter element of claim 2, wherein the second filter size is in a range of 10 microns to greater than 40 microns.

5. The filter element of claim 1, wherein the screen element has a frusto-conical shape surrounding an entry to the bypass valve within the cylindrical housing.

6. The filter element of claim 1, further comprising a mounting plate coupled to the second end of the cylindrical housing, the mounting plate configured to couple the filter element to a filter system of a hydraulic system.

7. The filter element of claim 1, wherein the screen element comprises a wire mesh and the filter material comprises a layered filter media.

8. A filter system comprising:
a cylindrical housing having a first end, a second end, and a longitudinal axis and defining:
an inlet positioned at a center portion of the first end; and
an outlet positioned at an annular portion of the first end surrounding the inlet;
a filter component comprising an annular cylinder of filter media arranged within the cylindrical housing;
a bypass opening positioned at the second end of the cylindrical housing; and
a screen element positioned adjacent the bypass opening within the cylindrical housing.

9. The filter system of claim 8, wherein the screen element comprises a mesh screen configured to separate contaminants from fluid passing through the filter system.

10. The filter system of claim 8, wherein the screen element comprises a frusto-conical shape surrounding the bypass opening.

11. The filter system of claim 8, further comprising a mounting plate coupled to the second end of the cylindrical housing, the mounting plate configured to couple the filter system to a hydraulic system.

12. The filter system of claim 11, wherein the outlet defines a passage through the cylindrical housing and the mounting plate.

13. The filter system of claim 8, wherein the filter media has a first filter size and the screen element has a second filter size, wherein the second filter size is greater than the first filter size.

14. The filter system of claim 8, wherein fluid flows through the inlet in a first direction parallel with the longitudinal axis and passes through the filter media in a flow direction that is radial to the longitudinal axis of the cylindrical housing and subsequently flows through the outlet in a second direction opposite the first direction.

15. A hydraulic fluid filter element comprising:
a housing comprising:
an inlet configured to receive hydraulic fluid from a hydraulic system;
an outlet configured to provide hydraulic fluid to the hydraulic system after filtering; and
a bypass outlet separate from the outlet, the bypass outlet and outlet configured to deliver hydraulic fluid along a single delivery vector;
a filter material positioned within the housing along a route between the inlet and the outlet; and
a screen element positioned adjacent the bypass outlet configured to separate solid contaminants from hydraulic fluid.

16. The hydraulic fluid filter of claim 15, wherein the hydraulic fluid filter element is removable from the hydraulic system for replacement.

17. The hydraulic fluid filter of claim 16, further comprising a mounting plate coupled to the housing, the mounting plate configured to couple the hydraulic fluid filter element to a filter system of the hydraulic system.

18. The hydraulic fluid filter of claim 15, wherein the filter material has a first filter size and the screen element has a second filter size, wherein the second filter size is greater than the first filter size.

19. The hydraulic fluid filter of claim 15, wherein the screen element comprises a mesh screen and the filter material comprises a layered filter media.

20. The hydraulic fluid filter of claim 15, wherein the bypass outlet comprises a controlled bypass valve configured to controllably open to enable hydraulic fluid to flow through the bypass outlet in parallel with the outlet.
